(19) United States
(12) Patent Application Publication
(10) Pub. No.: US 2025/0187477 A1
(43) Pub. Date: Jun. 12, 2025

(54) SYSTEMS AND METHODS FOR CONTROLLING CHARGING OF AN ELECTRIC VEHICLE

(71) Applicant: Solv4x Inc., Oakville (CA)

(72) Inventors: Sangharshan Katukoori, Oakville (CA); Rekha Sharma, Oakville (CA)

(21) Appl. No.: 18/971,878

(22) Filed: Dec. 6, 2024

Related U.S. Application Data
(60) Provisional application No. 63/607,834, filed on Dec. 8, 2023.

(51) Int. Cl. B60L 53/62; B60L 53/64; B60L 53/66; G06Q 30/0201; G06Q 50/06; G07C 5/02

(52) U.S. Cl. CPC B60L 53/62; B60L 53/64; B60L 53/66; G06Q 30/0206; G06Q 50/06; G07C 5/02

(57) ABSTRACT

A system and a computer-implemented method of controlling charging of an energy storage device of an electric vehicle are provided. The method may comprise: receiving a user optimization input indicating selection of an optimization factor for the charging of the energy storage device; receiving at least one of energy cost forecast data and energy greenness forecast data; generating a chargeability quotient based on the user optimization input and at least one of the energy cost forecast data and the energy greenness forecast data, the chargeability quotient indicating suitability of multiple time intervals of a control period for optimum charging of the energy storage device; receiving driver behavior data, energy storage device data and electric vehicle usage data; and controlling charging of the energy storage device during the multiple time intervals based on the chargeability quotient, the driver behavior data, the energy storage device data and the electric vehicle usage data.

### CROSS-REFERENCE TO RELATED APPLICATION

This application claims the benefit of U.S. Provisional Patent Application No. 63/607,834 filed Dec. 8, 2023, and the entire contents of U.S. Provisional Patent Application No. 63/607,834 are hereby incorporated herein in its entirety.

### FIELD

The described embodiments relate to system and methods for controlling charging of an energy storage device of an electric vehicle.

### BACKGROUND

The transportation sector is a significant contributor to global greenhouse gas emissions. Motor vehicles having internal combustion engines burn fossil fuels like gasoline and diesel to drive the vehicles and generate greenhouse gas emissions in the process. The greenhouse gas emission of the transportation sector can be reduced by using electric vehicles instead of internal combustion engine-based motor vehicles. An electric vehicle typically includes an energy storage device (e.g., a battery). The energy storage device stores electrical energy that can be used to drive the electric vehicle.

### SUMMARY

In a first aspect, there is provided a computer-implemented method of controlling charging of an energy storage device of an electric vehicle. The method comprises: receiving, by a processor, a user optimization input indicating selection of an optimization factor for the charging of the energy storage device, the optimization factor being a cost factor, an energy greenness factor, or a combined cost and energy greenness factor; receiving, by the processor, at least one of energy cost forecast data and energy greenness forecast data; generating, by the processor, a chargeability quotient based on the user optimization input and at least one of the energy cost forecast data and the energy greenness forecast data, the chargeability quotient indicating suitability of multiple time intervals of a control period for optimum charging of the energy storage device; receiving, by the processor, driver behavior data, energy storage device data and electric vehicle usage data; and controlling, by the processor, charging of the energy storage device during the multiple time intervals based on the chargeability quotient, the driver behavior data, the energy storage device data and the electric vehicle usage data.

In one or more embodiments, said controlling comprises inputting, by the processor, the chargeability quotient, the driver behavior data, the energy storage device data and the electric vehicle usage data into a decision tree model configured to generate an output for controlling charging of the energy storage device.

In one or more embodiments, said generating the chargeability quotient is further based on one or more user configurable threshold parameters for energy cost or energy greenness.

In one or more embodiments, said controlling comprises providing, by the processor, a control input to the electric vehicle via an application programming interface of the electric vehicle.

In one or more embodiments, the electric vehicle usage data comprises data indicating one or more of location, driving distances, driving times, and energy usage of the electric vehicle.

In one or more embodiments, the energy storage device data comprises data indicating one or more of energy storage capacity, stored energy status and charging rate of the energy storage device.

In one or more embodiments, the driver behavior data comprises data indicating energy efficiency of a driver of the electric vehicle.

In one or more embodiments, the at least one of energy cost forecast data and energy greenness forecast data is received from a neural network model trained using location-specific historical training data corresponding to one or more of energy cost, energy supply, energy consumption and environmental data.

In a second aspect, there is provided a system for controlling charging of an energy storage device of an electric vehicle. The system comprises a memory and a processor in communication with the memory. The processor is configured to: receive a user optimization input indicating selection of an optimization factor for the charging of the energy storage device, the optimization factor being a cost factor, an energy greenness factor, or a combined cost and energy greenness factor; receive at least one of energy cost forecast data and energy greenness forecast data; generate a chargeability quotient based on the user optimization input and at least one of the energy cost forecast data and the energy greenness forecast data, the chargeability quotient indicating suitability of multiple time intervals of a control period for optimum charging of the energy storage device; receive driver behavior data, energy storage device data and electric vehicle usage data; and control charging of the energy storage device during the multiple time intervals based on the chargeability quotient, the driver behavior data, the energy storage device data and the electric vehicle usage data.

In one or more embodiments, the memory is configured to store a decision tree model. The decision tree model is configured to generate an output for controlling charging of the energy storage device. The processor is further configured to control charging of the energy storage device by inputting the chargeability quotient, the driver behavior data, the energy storage device data and the electric vehicle usage data into the decision tree model.

In one or more embodiments, the processor is further configured to generate the chargeability quotient based on one or more user configurable threshold parameters for energy cost or energy greenness.

In one or more embodiments, the processor is configured to control charging of the energy storage device by providing a control input to the electric vehicle via an application programming interface of the electric vehicle.

In one or more embodiments, the electric vehicle usage data comprises data indicating one or more of location, driving distances, driving times, and energy usage of the electric vehicle.

In one or more embodiments, the energy storage device data comprises data indicating one or more of energy storage capacity, stored energy status and charging rate of the energy storage device.

In one or more embodiments, the driver behavior data comprises data indicating energy efficiency of a driver of the electric vehicle.

In one or more embodiments, the memory is configured to store a neural network model trained using location-specific historical training data corresponding to one or more of energy cost, energy supply, energy consumption and environmental data. The processor is configured to receive the at least one of energy cost forecast data and energy greenness forecast data from the neural network.

In a third aspect, there is provided a non-transitory computer readable medium storing thereon program instructions that are executable by a processor for performing a method of controlling charging of an energy storage device of an electric vehicle. The method comprises: receiving, by the processor, a user optimization input indicating selection of an optimization factor for the charging of the energy storage device, the optimization factor being a cost factor, an energy greenness factor, or a combined cost and energy greenness factor; receiving, by the processor, at least one of energy cost forecast data and energy greenness forecast data; generating, by the processor, a chargeability quotient based on the user optimization input and at least one of the energy cost forecast data and the energy greenness forecast data, the chargeability quotient indicating suitability of multiple time intervals of a control period for optimum charging of the energy storage device; receiving, by the processor, driver behavior data, energy storage device data and electric vehicle usage data; controlling, by the processor, charging of the energy storage device during the multiple time intervals based on the chargeability quotient, the driver behavior data, the energy storage device data and the electric vehicle usage data.

In one or more embodiments, said controlling comprises inputting, by the processor, the chargeability quotient, the driver behavior data, the energy storage device data and the electric vehicle usage data into a decision tree model configured to generate an output for controlling charging of the energy storage device.

In one or more embodiments, said generating the chargeability quotient is further based on one or more user configurable threshold parameters for energy cost or energy greenness.

In one or more embodiments, said controlling comprises providing, by the processor, a control input to the electric vehicle via an application programming interface of the electric vehicle.

In one or more embodiments, the electric vehicle usage data comprises data indicating one or more of location, driving distances, driving times, and energy usage of the electric vehicle.

In one or more embodiments, the energy storage device data comprises data indicating one or more of energy storage capacity, stored energy status and charging rate of the energy storage device.

In one or more embodiments, the driver behavior data comprises data indicating energy efficiency of a driver of the electric vehicle.

In one or more embodiments, the at least one of energy cost forecast data and energy greenness forecast data is received from a neural network model trained using location-specific historical training data corresponding to one or more of energy cost, energy supply, energy consumption and environmental data.

### BRIEF DESCRIPTION OF THE DRAWINGS

The drawings included herewith are for illustrating various examples of systems and methods of the teaching of the present specification and are not intended to limit the scope of what is taught in any way.

FIG. 1 is a schematic diagram that shows an example system for controlling charging of an energy storage device of an electric vehicle, in accordance with an embodiment.

FIG. 2 is a block diagram of the example system of FIG. 1.

FIG. 3 is a flowchart showing an example computer-implemented method, in accordance with an embodiment, of controlling charging of the energy storage device of FIG. 1.

FIG. 4 is a schematic diagram of an example neural network model used by the example system of FIG. 1, in accordance with an embodiment.

FIG. 5 is a schematic diagram of an example decision tree model used by the example system of FIG. 1, in accordance with an embodiment.

FIG. 6 is a visual representation of an example chargeability quotient, in accordance with an embodiment, for controlling charging of the energy storage device of FIG. 1.

### DETAILED DESCRIPTION

Several example embodiments are described herein. It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred to below as computing devices) may be a server, network appliance, embedded device, computer expansion module, personal computer, laptop, personal data assistant, cellular telephone, smart-phone device, tablet computer, wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and a combination thereof.

Program code may be applied to input data to perform the functions described herein and to generate output information. The output information is applied to one or more output devices, in known fashion.

Each program may be implemented in a high-level procedural or object-oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g., ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloads, magnetic and electronic storage media, digital and analog signals, and the like. The computer useable instructions may also be in various forms, including compiled and non-compiled code.

Various embodiments have been described herein by way of example only. Various modifications and variations may be made to these example embodiments without departing from the spirit and scope of the invention, which is limited only by the appended claims. Also, in the various user interfaces illustrated in the figures, it will be understood that the illustrated user interface text and controls are provided as examples only and are not meant to be limiting. Other suitable user interface elements may be possible.

The disclosed systems and methods can control charging of an energy storage device of an electric vehicle. One of the challenges associated with electric vehicles can be the frequent charging required for the energy storage device. For example, depending on the energy storage capacity of the energy storage device and the usage of the electric vehicle, the energy storage device may need to be charged every night.

The disclosed systems and method may automatically control charging of the energy storage device when the electric vehicle is not being driven and is connected to an electrical energy source. The disclosed systems and method may automatically control charging of the energy storage device based on the energy storage capacity of the energy storage device and the usage of the electric vehicle.

As described herein, controlling the charging of the energy storage device may include both supplying electrical energy to the energy storage device to charge up the energy storage device (e.g., supplying electrical energy from an electrical grid to the electric vehicle) and receiving electrical energy from the energy storage device to discharge the energy storage device (e.g., supplying electrical energy from the electric vehicle to the electrical grid).

The disclosed systems and methods may automatically control charging of the energy storage device to reduce cost and/or greenhouse gas emissions associated with the electrical energy supplied to the energy storage device. The disclosed systems and methods may enable a user to specify an optimization factor for the charging of the energy storage device. The optimization factor may be a cost factor, an energy greenness factor, or a combined cost and energy greenness factor. Based on the optimization factor, the disclosed systems and methods can optimize the charging of the energy storage device to reduce cost and/or greenhouse gas emissions.

To optimize charging of the energy storage device to reduce cost, the disclosed systems and methods may generate and/or receive energy cost forecast data. The cost associated with charging the energy storage device may be reduced by charging the energy storage device during periods of lower energy cost and avoiding charging the energy storage device during periods of higher energy cost. Optionally, the energy storage device may be discharged to supply energy to an electrical grid to generate revenue during periods of higher energy cost.

To optimize charging of the energy storage device to reduce greenhouse gas emissions, the disclosed systems and methods may generate and/or receive energy greenness forecast data. The greenhouse gas emissions associated with charging the energy storage device may be reduced by charging the energy storage device during periods when a larger proportion of the supplied electrical energy is generated using green energy sources like wind, solar, hydro etc. compared with other energy sources like coal and gas. Optionally, the energy storage device may be discharged to supply energy to an electrical grid to improve overall energy greenness mix during periods when a larger proportion of the grid energy is being generated using fossil fuel-based energy sources.

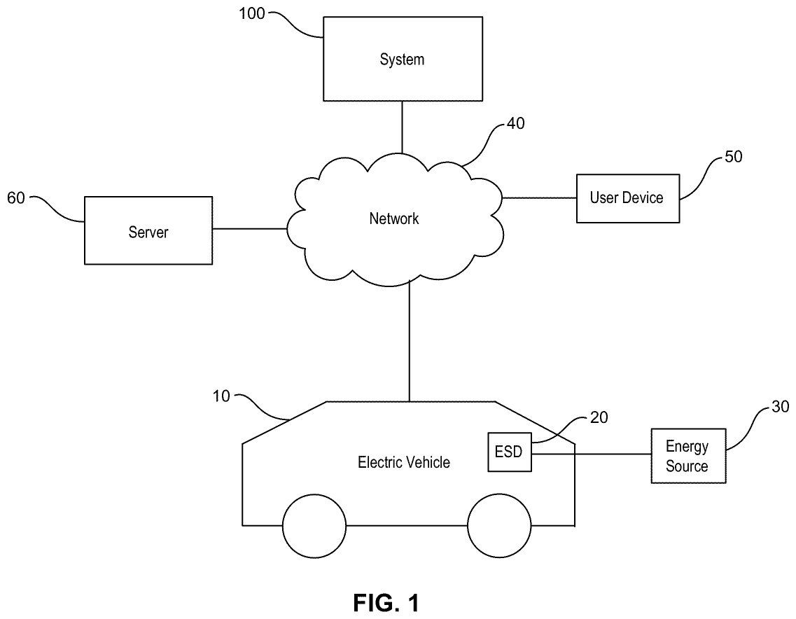

Referring first to FIG. 1, shown therein is a schematic diagram that includes an example system 100 for controlling charging of an energy storage device 20 of an electric vehicle 10. Also shown in FIG. 1 are an energy source 30, network 40, user device 50, and a server 60.

Electric vehicle 10 can be any motor vehicle that can receive electrical energy from an energy source and use the received electrical energy to drive electric vehicle 10. For example, electric vehicle 10 may include battery electric vehicles or plug-in hybrid electric vehicles.

Energy storage device 20 can be any suitable device that can store at least a portion of the electrical energy received by electric vehicle 10. The energy stored by energy storage device 20 may be used at a later time for driving electric vehicle 10. For example, energy storage device 20 may include lithium-ion batteries, nickel-metal hydride batteries, or ultracapacitors.

Energy source 30 can be any suitable energy source that electric vehicle 10 can be coupled with to receive electrical energy. For example, energy source 30 may include Level 1, Level 2 or Level 3 electric vehicle charging outlets. The electric vehicle charging outlets may receive electrical energy from an electrical grid.

Network 40 may include a communication network such as the Internet, a Wide-Area Network (WAN), a Local-Area Network (LAN), or another type of network. Network 40 may include a point-to-point connection, or another communications connection between two nodes.

User device 50 can include any networked device operable to connect to network 40. A networked device is a device capable of communicating with other devices through a network such as network 40. A networked device may couple to network 40 through a wired or wireless connection. User device 50 may include at least a processor and a communication interface. User device 50 may enable a user (e.g., an owner, a driver, a fleet manager etc. of electric vehicle 10) to communicate with system 100. User device 50 may include an electronic tablet device, a personal computer, a workstation, a portable computer, a mobile device, a personal digital assistant, a laptop, a smart phone, or any combination of these.

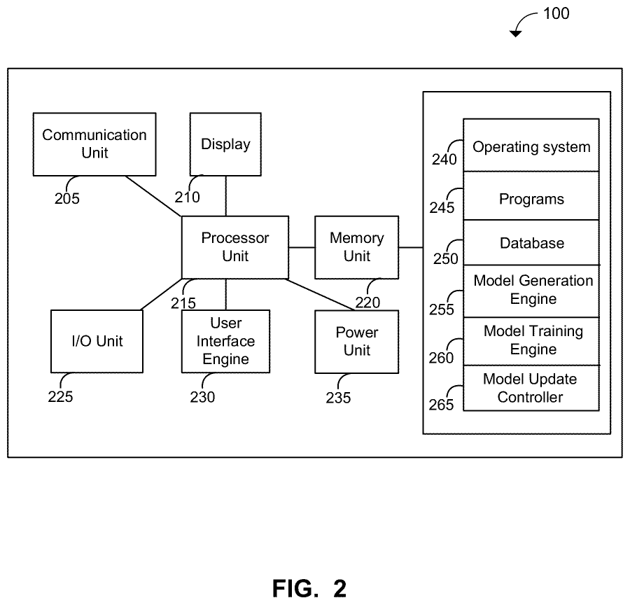

Reference is now made to FIGS. 1 and 2. FIG. 2 shows a block diagram of system 100, in accordance with an embodiment. In the illustrated example, system 100 includes a communication unit 205, a display 210, a processor unit 215, a memory unit 220, an I/O unit 225, a user interface engine 230 and a power unit 235.

Communication unit 205 may include wired or wireless connection capabilities. Communication unit 205 can be used by system 100 to communicate with other devices or computers. For example, system 100 may use communication unit 205 to receive (e.g., via network 40) energy cost forecast data, energy greenness forecast data, driver behavior data, energy storage device data and electric vehicle usage data from one or more external devices/computers (e.g., from server 60, electric vehicle 10 etc.). In some embodiments, system 100 may use communication unit 205 to provide a control input to electric vehicle 10 to control charging of energy storage device 20. For example, communication unit 205 may provide a control input to electric vehicle 10 via an application programming interface (API) of electric vehicle 10.

Display 210 may be a LED or LCD based display and may be a touch sensitive user input device that supports gestures. Display 210 may be integrated into system 100. Alternatively, display 210 may be located physically remote from system 100 and communicate with system 100 using a communication network, for example, network 40. In some embodiments, system 100 may not include a dedicated display 210. For example, system 100 may provide displays via display devices of server 60, user device 50, and/or electric vehicle 10.

Processor unit 215 may control the operation of system 100. Processor unit 215 can be any suitable processor, controller or digital signal processor that can provide sufficient processing power depending on the configuration, purposes and requirements of system 100 as is known by those skilled in the art. For example, processor unit 215 may be a high-performance general processor. As another example, processor unit 215 may include a standard processor, such as an Intel® processor, or an AMD® processor. Alternatively, processor unit 215 can include more than one processor with each processor being configured to perform different dedicated tasks. Alternatively, specialized hardware (e.g., graphical processing units (GPUs)) can be used provide some of the functions provided by processor unit 215.

Processor unit 215 may execute a user interface engine 230 that may be used to generate various user interfaces. User interface engine 230 may be configured to provide a user interface on display 210. Optionally, system 100 may be in communication with external displays via network 40 and user interface engine 230 may generate user interface data for the external displays (e.g., a display of user device 50).

I/O unit 225 may include at least one of a mouse, a keyboard, a touch screen, a thumbwheel, a trackpad, a trackball, a card-reader, voice recognition software and the like, depending on the particular implementation of system 100. In some cases, some of these components can be integrated with one another. I/O unit 225 may enable a user of electric vehicle 10 (e.g., an owner, a driver, a fleet manager etc.) to interact with system 100.

User interface engine 230 may be configured to provide a user interface to enable set-up and initialization of system 100. In some embodiments, user interface engine 230 may be configured to provide a user interface to receive a user optimization input indicating selection of an optimization factor for the charging of energy storage device 20.

Power unit 235 may be any suitable power source that provides power to system 100 such as a power adaptor or a rechargeable battery pack depending on the implementation of system 100 as is known by those skilled in the art.

Memory unit 220 may include software code for implementing an operating system 240, programs 245, database 250, model generation engine 255, model training engine 260, and model update controller 265. Memory unit 220 may include RAM, ROM, one or more hard drives, one or more flash drives or some other suitable data storage elements such as disk drives, etc.

Memory unit 220 may be used to store an operating system 240 and programs 245 as is commonly known by those skilled in the art. For instance, operating system 240 may provide various basic operational processes for system 100. For example, operating system 240 may be an operating system such as Windows® Server operating system, or Red Hat® Enterprise Linux (RHEL) operating system, or another operating system.

Programs 245 can include various programs so that system 100 can perform various functions such as, but not limited to, receiving user optimization input, energy cost forecast data, energy greenness forecast data, driver behavior data, energy storage device data and/or electric vehicle usage data; generating a chargeability quotient; and providing a control input to electric vehicle 10.

Database 250 may include a Structured Query Language (SQL) database such as PostgreSQL or MySQL or a not only SQL (NoSQL) database such as MongoDB, or Graph Databases, etc. Database 250 may be integrated with system 100. Alternatively, database 250 may run independently on a database server in network communication with system 100. For example, database 250 may run on server 60.

Database 250 may store the received energy cost forecast data, energy greenness forecast data, driver behavior data, energy storage device data and/or electric vehicle usage data. In some embodiments, database 250 may store one or more A1 or machine learning models. The models may be generated by system 100 or may be received by system 100 from an external device (e.g., server 60). As one example, database 250 may store a charging control model that is configured to generate an output for controlling charging of energy storage device 20. As another example, database 250 may store an energy forecast model that is configured to generate an energy cost forecast output and/or an energy greenness forecast output.

Model generation engine 255 may generate one or more Al or machine learning models. For example, model generation engine 255 may generate a charging control model and/or an energy forecast model. The charging control model may be configured to receive a chargeability quotient, driver behavior data, energy storage device data and electric vehicle usage data as inputs and generate an output for controlling charging of energy storage device 20. The energy forecast model may be configured to receive historic energy cost data, historic energy greenness mix data, holiday schedule data, and environmental data as inputs and generate an energy cost forecast output and/or an energy greenness forecast output.

In some embodiments, system 100 may not include a model generation engine 255. System 100 may receive one or more models (e.g., a charging control model, an energy forecast model, etc.) from an external device (e.g., server 60). The generated and/or received models may be stored in database 250. In some embodiments, the generated and/or received models may be stored in an external storage device that is in network communication with system 100.

Model training engine 260 can train one or more A1 or machine learning models. The models may include models generated by model generation engine 255 and/or models received from external devices. For example, model training engine 260 may train the charging control model and/or the energy forecast model.

Model training engine 260 may be configured to perform training of models at various times. For example, model training engine 260 may be configured to train models when they are initially generated by model generation engine 255. Model training engine 260 may also be configured to train models based on a time-based schedule. For example, based on a training period parameter stored in database 250. In some embodiments, model training engine 260 may train a model in response to a training request. The training request may be generated, for example, by model update controller 265 or may be received from an external device (e.g., user device 50 or server 60).

Model training engine 260 may use any suitable training method to train the models based on factors including the type of model, available training data, available computational resources, and/or the requirements of system 100. Model training engine 260 may receive training data from an external device (e.g., server 60).

As one example, model training engine 260 may use location-specific historical training data for training the energy forecast model. The location-specific historical training data may include energy consumption data, energy cost data (e.g., electricity rates ($/MWh)), energy supply data including energy greenness mix data (e.g., proportion of energy being generated using fossil fuel sources versus non-fossil fuel sources), holiday schedule data (e.g., weekends or any holidays like Christmas, Thanksgiving, etc. that may change energy usage patterns) and environmental data (e.g., temperature, wind speed, wind direction, dewpoint, precipitation, etc.) for a historical time period. The environmental data may include data for environmental factors that impact generation of electrical energy from non-fossil fuel sources (green energy), e.g., wind, solar, etc.

In some embodiments, a random forest algorithm may be used to select a subset of inputs that have the highest impact on the predicted energy cost/greenness output. This may enable higher computing efficiency by reducing the input data provided to the energy forecast model.

Any suitable historical time period may be used. For example, the historical time period may be in a range from 15 days to 6 years. In some examples, the historical time period may be shorter than 15 days. Shorter historical time periods may require less data, consume reduced computation resources and/or enable faster model training. In some examples, the historical time period may be longer than 6 years. Longer historical time periods may enable models to be trained for higher output accuracy.

In some embodiments, model training engine 260 may filter received training data for data quality and generate a filtered training data. Model training engine 260 may reserve a portion of received training data as validation data and utilize the remaining portion for training a model. Model training engine 260 may use the validation data to evaluate the performance of a trained model. Model training engine 260 may continue training the model until the model achieves a threshold output accuracy level for the validation data.

Model update controller 265 may control updates of one or more models of system 100. For example, model update controller 265 may control updates of the charging control model and/or the energy forecast model. For example, model update controller 265 may receive input data describing actual energy cost and/or energy greenness mix for a time period that the energy forecast model had previously generated an output for. Model update controller 265 may compare the generated output with the actual energy cost and/or energy greenness mix to determine an accuracy of the generated output. Model update controller 265 may provide a control signal to model training engine 260 to retrain the energy forecast model in response to the determined accuracy not meeting an accuracy requirement.

As another example, model update controller 265 may determine an optimum energy cost performance (or energy greenness mix performance) of the electric vehicle 10 for a time period that the charging control model had previously generated a charging control output for. The optimum energy cost performance may be based on actual energy cost (or energy greenness mix) and usage of electric vehicle 10 during the time period. Model update controller 265 may determine an actual energy cost performance (or energy greenness mix performance) of the electric vehicle 10 that was achieved based on the output generated by the charging control model. Model update controller 265 may compare the optimum energy cost performance with the actual energy cost performance. Model update controller 265 may provide a control signal to model training engine 260 to retrain the charging control model and/or the energy forecast model in response to the actual energy cost performance not being within a threshold level of the optimum energy cost performance.

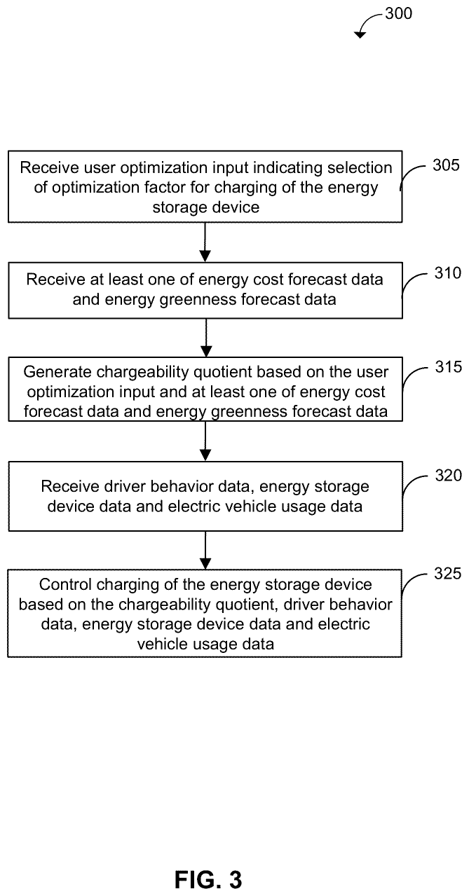

Referring now to FIG. 3, shown therein is a flowchart showing an example computer-implemented method 300 of controlling charging of an energy storage device of an electric vehicle. For example, method 300 may be used to control charging of energy storage device 20 of electric vehicle 10. Method 300 may be implemented using any suitable system. For example, method 300 may be implemented using system 100 and reference is now made concurrently to FIGS. 1 to 3.

Method 300 may be performed at various times. For example, method 300 may be performed in response to electric vehicle 10 being connected to energy source 30. As another example, method 300 may be performed in response to an input received from a user (e.g., an owner, driver, fleet manager etc. of electric vehicle 10). The user input may be received from an external device, e.g., user device 50, server 60. In some examples, method 300 may be performed based on a stored time schedule (e.g., at a specified time of day, at a specified time interval from a previous execution of the method etc.).

At act 305, method 300 may include receiving a user optimization input indicating selection of an optimization factor for the charging of the energy storage device. For example, system 100 may receive a user optimization input from a user (e.g., an owner, driver, fleet manager etc. of electric vehicle 10). The user input may be received from an external device (e.g., user device 50).

The user optimization input may indicate to system 100 to optimize charging of energy storage device 20 based on energy cost, energy greenness mix, or a combination of energy cost and energy greenness mix. For example, if the user optimization input indicates optimization of charging of energy storage device 20 based on energy cost, system 100 may control the charging process to minimize energy cost. System 100 may minimize energy cost by charging energy storage device 20 at forecasted time periods of low energy cost and avoid charging energy storage device 20 at forecasted time periods of high energy cost.

In examples where a combination of energy cost and energy greenness mix is selected for optimization, the user optimization input may further indicate to system 100 a relative weighting of the energy cost and energy greenness mix factors. As one example, the user optimization input may indicate weighting coefficients for energy cost (e.g., weighting coefficient of 0.6) versus energy greenness mix (e.g., weighting coefficient of 0.4). As another example, the user optimization input may indicate optimization of charging of energy storage device 20 to minimize energy cost while maintaining energy greenness above 80%.

At act 310, method 300 may include receiving at least one of energy cost forecast data and energy greenness forecast data. The energy cost forecast data and energy greenness forecast data may correspond to any suitable forecast period. Any suitable forecast period may be used. For example, forecast periods may be in a range from 4 hours to 48 hours. In some examples, forecast periods may be shorter than 4 hours. Shorter forecast periods may correspond to smaller amounts of forecasted energy cost/greenness data and consume lower computational resources. In some examples, forecast periods may be longer than 48 hours. Longer forecast periods may correspond to larger amounts of forecasted energy cost/greenness data and enable greater energy cost/greenness optimization during charging of the energy storage device.

In some embodiments, method 300 may be launched each time new energy cost forecast data or energy greenness forecast data is received. For example, new energy cost/greenness forecast data may be received at 1 hour time intervals. The data may correspond to a forecasted time period of 24 hours. In this example, method 300 may be executed at 1 hour time intervals and generate a charging control output for a 24-hour time period each time method 300 is executed.

In some embodiments, processor unit 215 of system 100 may receive forecasted energy cost data and/or forecasted energy greenness data from an external device (e.g., server 60). In some embodiments, processor unit 215 may receive forecasted energy cost data and/or forecasted energy greenness data from a trained energy forecast model that is stored at system 100 (e.g., in database 250). Processor unit 215 may provide real-time and/or forecasted location-specific environmental data as input to the trained energy forecast model. The real-time and/or forecasted location-specific environmental data may be received from an external device (e.g., server 60). Processor unit 215 may receive predicted energy cost forecast data and energy greenness forecast data from the trained energy forecast model.

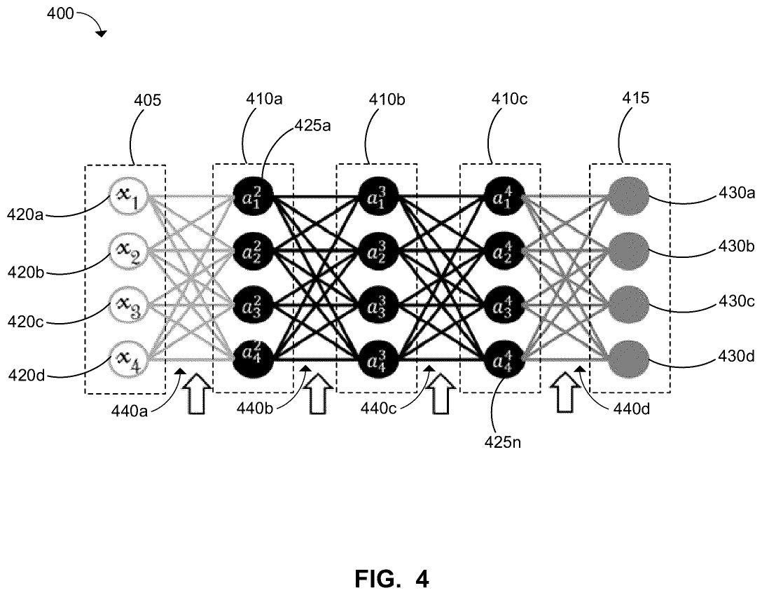

The energy forecast model can be any suitable Al or machine learning model. In some embodiments, the energy forecast model may be a neural network model. Referring now to FIG. 4, shown therein is a schematic diagram of an example neural network model 400. As shown in FIG. 4, neural network model 400 may include an input layer 405, multiple hidden layers 410a-410c (also referred to herein as hidden layer(s) 410) and an output layer 415.

Each layer of neural network model 400 may include one or more activation units, also referred to as neurons. For example, input layer 405 may include neurons 420a-420d. Output layer 415 may include neurons 430a-430d. The hidden layers 410a-410c may include neurons 425a-425n. The layers of neural network model 400 may be interconnected using weighted connections 440a-440d (also referred to herein as weighted connections 440). The weighted connections 440 may enable the outputs computed by neurons in one layer to be propagated as inputs to the next layer. For example, the weighted connections 440c may enable the outputs computed by neurons in layer 410b to be propagated to the neurons in layer 410c. Model training engine 260 may adjust the weighted connections 440 during the training of model 400.

In some embodiments, the energy forecast model may include other models including a long short-term memory (LSTM) network, an autoregressive integrated moving average (ARIMA) model, a seasonal autoregressive integrated moving average (SARIMA) model, etc.

At act 315, method 300 may include generating a chargeability quotient based on the user optimization input received at act 305, and the energy cost forecast data and/or the energy greenness forecast data received at act 310. For example, processor unit 215 may generate the chargeability quotient based on user optimization input received from user device 50 and energy cost forecast data (or energy greenness forecast data) received from a trained energy forecast model.

The chargeability quotient may indicate suitability of multiple time intervals of a control period for optimum charging of the energy storage device. The control period may be any suitable time duration. For example, method 300 may generate an output for controlling charging of energy storage device 20 during a rolling 24-hour period. Each time method 300 is executed, an output for controlling charging of energy storage device 20 during the next 24-hour period may be generated. The 24-hour control period may be divided into smaller time intervals. The smaller time intervals may be any suitable time duration. For example, the 24-hour control period may be divided into 1-hour time intervals and the charging quotient may indicate the charging suitability of each 1-hour time interval during the 24-hour control period.

In other examples, other control period durations and/or other time interval durations may be used. For example, control period durations in a range from 4 hours to 48 hours may be used. For shorter control period durations, method 300 may be executed more frequently and may be more responsive to changes in data and/or forecasts. For longer control period durations, method 300 may be executed less frequently and may require lower computational resources.

The time interval durations may be based on the control period duration being used. In some examples, time interval durations may be in a range from 15 minutes to 4 hours. In other examples, time interval durations shorter than 15 minutes or longer than 4 hours may be used.

In some embodiments, a shorter time interval duration of 15 minutes may be used in combination with a shorter control period of 4 hours and a longer time interval duration of 4 hours may be used in combination with a longer control period of 48 hours. In other embodiments, a shorter time interval duration (e.g., 30 minutes) may be used in combination with a longer control period duration (e.g., 24 hours) to provide a larger number of control time intervals (48 control time intervals during the 24-hour control period duration in this example). In some examples, a longer time interval duration (e.g., 3 hours) may be used in combination with a shorter control period duration (e.g., 12 hours) to provide a smaller number of control time intervals (4 control time intervals during the 12-hour control period duration in this example).

Method 300 may provide greater control of the charging of the energy storage device and provide greater energy cost/greenness efficiency when shorter time interval durations and/or greater number of control time intervals are used. Method 300 may utilize lower computational resources when longer time interval durations and/or smaller number of control time intervals are used.

In some embodiments (e.g., as described in the above examples), the control time period may be divided into time intervals of equal duration. In other embodiments, the control time period may be divided into time intervals of unequal durations.

The chargeability quotient may indicate suitability of each control time interval of the control time period using any suitable indicator. For example, the chargeability quotient may use a scale from 0 to 3 to indicate the suitability, where “0” indicates lowest suitability level (e.g., do not charge), “3” indicates highest suitability level (e.g., always charge) and “1”, “2” indicate intermediate suitability levels (e.g., charge/do not charge based on other factors). In other examples, the chargeability quotient may use any other suitable scales to indicate the charging suitability for a control time interval (e.g., a binary 0/1 scale, a scale from 0 to 10 etc.).

In some embodiments, the chargeability quotient may be based on one or more user configurable threshold parameters (in addition to the user optimization input and energy cost/greenness forecast data). The user configurable threshold parameters may be provided by a user (e.g., a driver, an owner, a fleet manager of electric vehicle 10). This may provide the user greater control over optimization of the charging of energy storage device 20.

As one example, the user optimization input may indicate selection of an energy cost optimization factor. The user configurable threshold parameters may set the threshold cost levels corresponding to each suitability level of the chargeability quotient. Assuming chargeability quotient suitability levels of 0 to 3 for this example, the user configurable threshold parameters may set the following threshold energy cost levels—$1 or below (suitability level “3”), $1 to $10 (suitability level “2”), $10 to $15 (suitability level “1”), and $15 or higher (suitability level “0”).

As another example, the user optimization input may indicate selection of an

energy greenness optimization factor. The user configurable threshold parameters may set the threshold energy greenness levels corresponding to each suitability level of the chargeability quotient. Assuming chargeability quotient suitability levels of 0 to 4 for this example, the user configurable threshold parameters may set the following threshold energy greenness levels—90% or above (suitability level “4”), 80% to 90% (suitability level “3”), 70% to 80% (suitability level “2”), 60% to 70% (suitability level “1”), and 60% or below (suitability level “0”).

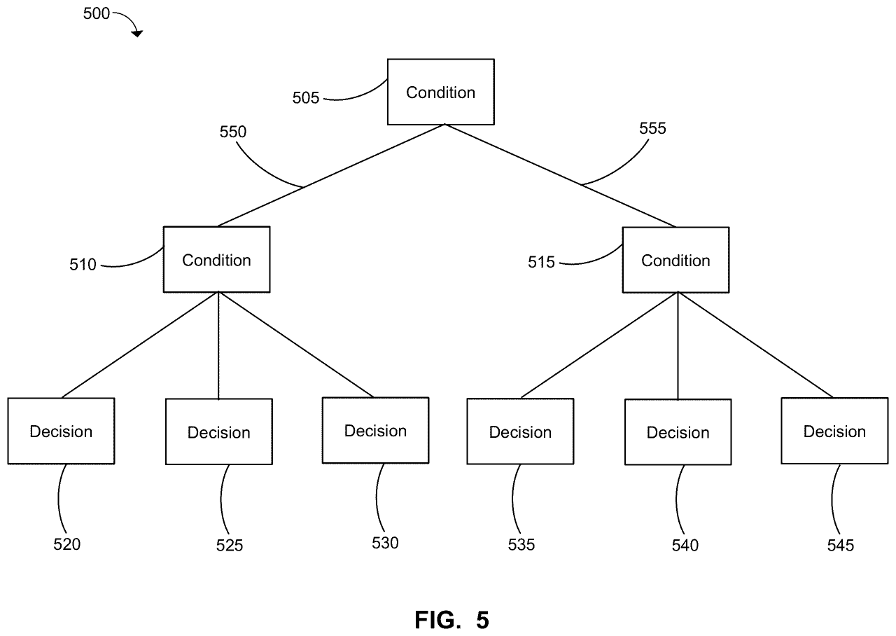

In some embodiments, processor unit 215 may generate the chargeability quotient based on a decision tree model. Referring now to FIG. 5, shown therein is a schematic diagram of an example decision tree model 500. As shown in FIG. 5, decision tree model 500 may include multiple condition nodes (e.g., 505, 510, 515) and multiple decision nodes (e.g., 520 to 545). At each condition node, a condition may be evaluated, and any one of two or more branches may be selected based on the evaluation. For example, based on the condition evaluated at condition node 505, either branch 550 to condition node 510 or branch 555 to condition node 515 may be selected.

At each decision node, a decision may be taken. For example, at condition node 510 a forecasted energy cost may be compared with multiple threshold energy cost levels. Based on the evaluation at condition node 510, a suitability level of “0”, “1”, or “2” may be assigned at decision nodes 520, 525 or 530 respectively. The decision tree model may be implemented, for example, using nested “If . . . else” statements. In other embodiments, processor unit 215 may use any other suitable method to generate the chargeability quotient.

At act 320, method 300 may include receiving electric vehicle usage data, energy storage device data, and driver behavior data. The electric vehicle usage data, energy storage device data, and/or driver behavior data may be received from an external device, e.g., server 60, electric vehicle 10, user device 50 etc.

The electric vehicle usage data, energy storage device data, and/or driver behavior data may include historic and/or real-time data. The historic data may be for any suitable period. In some examples, the historic period may be in a range from 10 days to 120 days. In other examples, the historic period may be shorter than 10 days or longer than 120 days. Shorter periods may reduce the amount of data to be processed and require lower computational resources. Larger periods may provide larger amount of data that may enable greater energy cost/greenness optimization.

The electric vehicle usage data may include data indicating location, driving distances, driving times, and/or energy usage of the electric vehicle. For example, the electric vehicle usage data may include data indicating what times electric vehicle 10 is driven (e.g., between 9 am to 5 pm) and what times electric vehicle 10 is parked and available for charging (e.g., between 5 pm and 9 am). As another example, the electric vehicle usage data may include data indicating the distances that electric vehicle 10 is driven and the corresponding energy usage.

In some embodiments, a unique energy storage device ID may be associated with each energy storage device. The unique energy storage device ID may be used by method 300 to track real-time and historic energy performance of the energy storage device. The unique energy storage device ID may be stored, for example, in database 250.

The energy storage device data may include real-time data indicating an energy storage capacity and/or a stored energy status of the energy storage device. In some embodiments, the energy storage device data may include historic data indicating stored energy levels, charging times corresponding to charging between different energy levels required etc. of the energy storage device.

The driver behavior data may include data indicating one or more behaviors of a driver that impacts energy efficiency of electric vehicle 10. The driver behaviors may include driving speeds, frequency of braking etc. For an identical driving task using the same electric vehicle 10 and energy storage device 20, driver A may achieve a driving range of 400 km while driver B may achieve a driving range of 430 km based on their corresponding driver behaviors. The driver behavior data may include a driver efficiency factor for a driver indicating an energy efficiency behavior of that driver.

At act 325, method 300 may include controlling charging of the energy storage device based on the chargeability quotient generated at act 315, and the driver behavior data, the energy storage device data and the electric vehicle usage data received at act 320. For example, processor unit 215 may generate a control input signal that is provided to electric vehicle 10 to control charging of energy storage device 20.

The control input signal may be provided to electric vehicle 10 via an application programming interface of electric vehicle 10. This may enable direct automatic control of charging of energy storage device without any intermediate control devices or human intervention. In some embodiments, a graphical representation of the control input signal may be provided at a user interface (e.g., a user interface generated by user interface engine 230). A user (e.g., a driver, an owner, a fleet manager of electric vehicle 10) may control the charging of the energy storage device based on the graphical representation.

The control input signal may be a binary signal corresponding to two control states—hold (where the energy storage device is not charged) and charge (where the energy storage device is charged). In some embodiments, the control input signal may correspond to three control states—hold (where the energy storage device is not charged or discharged), charge (where the energy storage device is charged) and discharge (where the energy storage device is discharged).

Processor unit 215 may generate the control input signal by inputting the chargeability quotient, driver behavior data, energy storage device data and electric vehicle usage data into a charging control model. Any suitable charging control model may be used. In some embodiments, the charging control model may include a decision tree model (e.g., as described herein above with reference to FIG. 5). In other embodiments, the charging control model may include different models, e.g., a logistic regression model, a conditional inference tree etc.

The chargeability quotient may provide efficient data transfer between different acts of method 300. For example, an energy forecast model at act 310 may operate independently of a charging control model at act 325. The energy forecast model may generate energy cost/greenness forecasts at any suitable frequency that is same or different compared with the output frequency of the charging control model. For example, the energy forecast model may generate updated energy cost/greenness forecasts at a 15-minute frequency while the charging control model may generate a control output at an hourly frequency.

The chargeability quotient may also reduce complexity of the charging control model because a single chargeability quotient input may be provided to the charging control model instead of multiple inputs used to generate the energy cost/greenness forecast (e.g., various environmental data including temperature, wind speed, wind direction, dewpoint, precipitation, etc.).

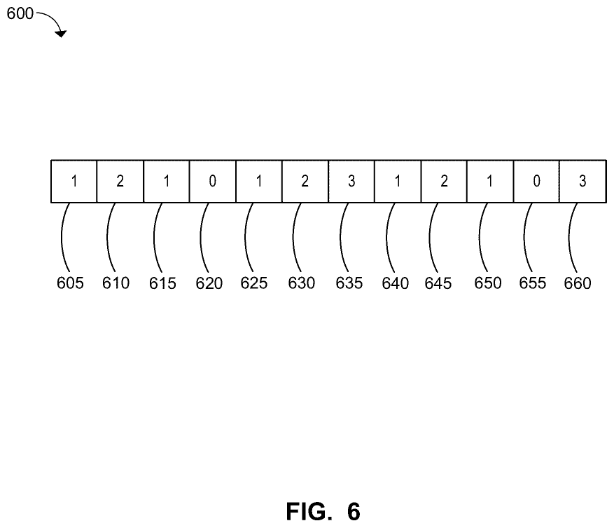

Referring now to FIG. 6, shown therein is a visual representation of an example chargeability quotient 600 for controlling charging of an energy storage device during control time intervals 605-660. Chargeability quotient 600 may be generated, for example, at act 315.

Processor unit 215 may generate the control input signal based on chargeability quotient 600 and the received driver behavior data, energy storage device data and electric vehicle usage data. For example, the driver behavior data, energy storage device data and electric vehicle usage data may indicate that the energy storage device is available for charging during time intervals 615 to 655 and that the energy storage device is required to be charged for three time intervals during this period. In this example, based on the chargeability quotient 600, processor unit 215 may generate a control input signal to charge the energy storage device during time intervals 630, 635 and 645 corresponding to chargeability quotient values of “2”, “3”, and “2”.

In some embodiments, processor unit 215 may generate a modified control input signal based on an override input signal received from a user (e.g., a driver, an owner, a fleet manager etc. of electric vehicle 10). The override input signal may be received from any suitable device (e.g., user device 50, server 60 etc.). As one example, in response to an emergency event, charging of energy storage device 20 may be required to be completed by end of time interval 640 in the above-described example. A user may provide an override input signal to charge energy storage device 20 during time interval 640 (instead of during time interval 645).

Optionally, at act 325, method 300 may include generating a report indicating the energy cost/greenness performance associated with charging of energy storage device 20 of electric vehicle 10. The report may be provided to a user (e.g., a driver, an owner, a fleet manager etc. of electric vehicle 10). The report may be provided at an external device (e.g., user device 50, server 60 etc.). In some embodiments, the report may be automatically generated (e.g., based on a stored time schedule). In some embodiments, the report may be generated in response to a user input.

The present invention has been described here by way of example only. Various modification and variations may be made to these exemplary embodiments without departing from the spirit and scope of the invention, which is limited only by the appended claims.

We claim:

1. A computer-implemented method of controlling charging of an energy storage device of an electric vehicle, the method comprising:
receiving, by a processor, a user optimization input indicating selection of an optimization factor for the charging of the energy storage device, the optimization factor being a cost factor, an energy greenness factor, or a combined cost and energy greenness factor;
receiving, by the processor, at least one of energy cost forecast data and energy greenness forecast data;
generating, by the processor, a chargeability quotient based on the user optimization input and at least one of the energy cost forecast data and the energy greenness forecast data, the chargeability quotient indicating suitability of multiple time intervals of a control period for optimum charging of the energy storage device;
receiving, by the processor, driver behavior data, energy storage device data and electric vehicle usage data; and
controlling, by the processor, charging of the energy storage device during the multiple time intervals based on the chargeability quotient, the driver behavior data, the energy storage device data and the electric vehicle usage data.

2. The method of claim 1, wherein said controlling comprises inputting, by the processor, the chargeability quotient, the driver behavior data, the energy storage device data and the electric vehicle usage data into a decision tree model configured to generate an output for controlling charging of the energy storage device.

3. The method of claim 1, wherein said generating the chargeability quotient is further based on one or more user configurable threshold parameters for energy cost or energy greenness.

4. The method of claim 1, wherein said controlling comprises providing, by the processor, a control input to the electric vehicle via an application programming interface of the electric vehicle.

5. The method of claim 1, wherein the electric vehicle usage data comprises data indicating one or more of location, driving distances, driving times, and energy usage of the electric vehicle.

6. The method of claim 1, wherein the energy storage device data comprises data indicating one or more of energy storage capacity, stored energy status and charging rate of the energy storage device.

7. The method of claim 1, wherein the driver behavior data comprises data indicating energy efficiency of a driver of the electric vehicle.

8. The method of claim 1, wherein the at least one of energy cost forecast data and energy greenness forecast data is received from a neural network model trained using location-specific historical training data corresponding to one or more of energy cost, energy supply, energy consumption and environmental data.

9. A system for controlling charging of an energy storage device of an electric vehicle, the system comprising a memory and a processor in communication with the memory, the processor being configured to:
receive a user optimization input indicating selection of an optimization factor for the charging of the energy storage device, the optimization factor being a cost factor, an energy greenness factor, or a combined cost and energy greenness factor;
receive at least one of energy cost forecast data and energy greenness forecast data;
generate a chargeability quotient based on the user optimization input and at least one of the energy cost forecast data and the energy greenness forecast data, the chargeability quotient indicating suitability of multiple time intervals of a control period for optimum charging of the energy storage device;
receive driver behavior data, energy storage device data and electric vehicle usage data; and
control charging of the energy storage device during the multiple time intervals based on the chargeability quotient, the driver behavior data, the energy storage device data and the electric vehicle usage data.

10. The system of claim 9, wherein the memory is configured to store a decision tree model, the decision tree model being configured to generate an output for controlling charging of the energy storage device; and the processor is further configured to control charging of the energy storage device by inputting the chargeability quotient, the driver behavior data, the energy storage device data and the electric vehicle usage data into the decision tree model.

11. The system of claim 9, wherein the processor is further configured to generate the chargeability quotient based on one or more user configurable threshold parameters for energy cost or energy greenness.

12. The system of claim 9, wherein the processor is configured to control charging of the energy storage device by providing a control input to the electric vehicle via an application programming interface of the electric vehicle.

13. The system of claim 9, wherein the electric vehicle usage data comprises data indicating one or more of location, driving distances, driving times, and energy usage of the electric vehicle.

14. The system of claim 9, wherein the energy storage device data comprises data indicating one or more of energy storage capacity, stored energy status and charging rate of the energy storage device.

15. The system of claim 9, wherein the driver behavior data comprises data indicating energy efficiency of a driver of the electric vehicle.

16. The system of claim 9, wherein the memory is configured to store a neural network model trained using location-specific historical training data corresponding to one or more of energy cost, energy supply, energy consumption and environmental data; and the processor is configured to receive the at least one of energy cost forecast data and energy greenness forecast data from the neural network.

17. A non-transitory computer readable medium storing thereon program instructions that are executable by a processor for performing a method of controlling charging of an energy storage device of an electric vehicle, the method comprising:
receiving, by the processor, a user optimization input indicating selection of an optimization factor for the charging of the energy storage device, the optimization factor being a cost factor, an energy greenness factor, or a combined cost and energy greenness factor;
receiving, by the processor, at least one of energy cost forecast data and energy greenness forecast data;
generating, by the processor, a chargeability quotient based on the user optimization input and at least one of the energy cost forecast data and the energy greenness forecast data, the chargeability quotient indicating suitability of multiple time intervals of a control period for optimum charging of the energy storage device;
receiving, by the processor, driver behavior data, energy storage device data and electric vehicle usage data;
controlling, by the processor, charging of the energy storage device during the multiple time intervals based on the chargeability quotient, the driver behavior data, the energy storage device data and the electric vehicle usage data.

18. The non-transitory computer readable medium of claim 17, wherein said controlling comprises inputting, by the processor, the chargeability quotient, the driver behavior data, the energy storage device data and the electric vehicle usage data into a decision tree model configured to generate an output for controlling charging of the energy storage device.

19. The non-transitory computer readable medium of claim 17, wherein said generating the chargeability quotient is further based on one or more user configurable threshold parameters for energy cost or energy greenness.

20. The non-transitory computer readable medium of claim 17, wherein said controlling comprises providing, by the processor, a control input to the electric vehicle via an application programming interface of the electric vehicle.
